(19) United States
(12) Patent Application Publication
(10) Pub. No.: US 2011/0231629 A1
(43) Pub. Date: Sep. 22, 2011

(54) DATA PROCESSING APPARATUS AND DATA PROCESSING METHOD

(76) Inventor: Naoto SHIRAISHI, Kanagawa (JP)

(21) Appl. No.: 13/043,695

(22) Filed: Mar. 9, 2011

(30) Foreign Application Priority Data
Mar. 16, 2010 (JP) 2010-060008

(51) Int. Cl. G06F 12/10

(52) U.S. Cl. 711/206; 711/E12.061

(57) ABSTRACT

A data processing apparatus includes: a slide storage unit sequentially storing input data; a search unit searching for a data string, stored in the slide storage unit, matched with an input data string including the input data that is continuously input; a length generation unit selecting one from the data string, obtaining a length, and generating a length value; an address value generation unit obtaining a position, in the slide storage unit, of start data in the data string and generating an address value; a translation unit translating a predetermined number of address values among address values having a high appearance frequency among address values generated by the address value generation unit into a translation address value having a value equal to or smaller than a predetermined value according to the appearance frequency of the address value; and an encoding unit encoding the length value and the translation address value.

### CROSS-REFERENCE TO RELATED APPLICATIONS

The present application claims priority to and incorporates by reference the entire contents of Japanese Patent Application No. 2010-060008 filed in Japan on Mar. 16, 2010.

### BACKGROUND OF THE INVENTION

1. Field of the Invention

The present invention relates to a data processing apparatus and a data processing method for encoding and decoding data.

2. Description of the Related Art

In the related art, there has been performed the compression-encoding of a program or data (hereinafter, collectively referred to as “data” unless set forth otherwise) stored in a secondary storage medium such as a hard disk drive (HDD). As data is compression-encoded and stored in the HDD, a storage area can be saved, and as a result more data can be stored. Further, since the data size of the stored data is reduced by compression-encoding, there is an effect of improving the speed in gaining an access to the HDD.

Japanese Patent Application Laid-open No. 7-319743 discloses a technique in which a reference frequency or attribute value is added to data to be stored in the HDD, data having a high access frequency is not compression-coded, and data having a low access frequency is compression-coded and stored in the HDD. According to Japanese Patent Application Laid-open No. 7-319743, the speed of accessing the HDD including compression encoding and decoding processes of data can be improved.

Further, there has recently been known a technique in which, in order to activate a device in a dormant state at a high speed, when the device makes a transition to the dormant state, a snapshot where a memory state is imaged is retained, and when the device returns from the dormant state, the snapshot is reloaded at an original memory location, so that the memory state is restored to the state at the time of snapshot acquisition. Japanese Patent Application Laid-open No. 2004-178289 discloses a method of acquiring a snapshot in units of partitions, files, or directories.

Further, there has recently been put to practical use a technique called hibernation that increases an activation speed when returning from the dormant state such as a power save mode by retaining a snapshot in which a main storage device state is entirely imaged in the HDD.

In the meantime, as an efficient data compression scheme, a scheme of performing compression by universal coding has been put into practical use. Universal coding is a lossless data compression scheme and can be applied to data of various types (for example, character code and an object code) because a statistical nature of an information source is not previously supposed at the time of data compression.

A representative universal coding scheme includes Ziv-Lempel coding. In Ziv-Lempel coding, two algorithms of a universal type and an incremental parsing type have been suggested. Of these, as a practical scheme using a universal type algorithm, there is Lempel-Ziv-Storer-Syzmanski (LZSS) coding.

In an encoding algorithm of LZ77 coding, which becomes the basis of LZSS coding, encoding data are divided into strings of a maximum length matching from an arbitrary position of a past data string and these are encoded as a duplicate of the past data string.

More specifically, a moving window that stores encoded input data and a lookahead buffer that stores data to be encoded are provided, and a data string of the lookahead buffer is compared with all partial strings of a data string of the moving window to obtain a matching partial string of a maximum length in the moving window. In order to designate this partial string of the maximum length in the moving window, a set of “a start position of the partial string of the maximum length,” “a matching length,” and “a next symbol that yields a mismatch” is encoded.

Next, the encoded data string in the lookahead buffer is moved to the moving window, and a new data string, which corresponds to the encoded data string, is input to the lookahead buffer. Thereafter, the same processing is repeated, so that data is decomposed into partial data strings and encoded.

In the hibernation, the snapshot in which the main storage device state is entirely imaged is created. That is, the snapshot created by the hibernation includes code data of a program operated directly before the snapshot is created.

In recent years, since most of central processing units (CPUs) use a reduced instruction set computer (RISC) technique, in code data of a program based on a machine language, commands are lined up in units of 4 bytes or 8 bytes, and there is a high possibility that data will be matched every 4 bytes or 8 bytes. Further, when a peak of a matching possibility of every 4 bytes or 8 bytes is ignored and the whole is considered, a similar probability continues such as in bytes that have recently appeared, a matching possibility is high, and in bytes that are at some distance, a matching possibility is low.

For the forgoing reasons, there has been a problem in that encoding efficiency is not so good even if static Huffman encoding is performed on a matching position by using the above described universal coding. Further, since a hardware structure is complicated for the encoding efficiency, there has been a problem in that a design cost would increase and a possibility of generating the bug would increase.

### SUMMARY OF THE INVENTION

It is an object of the present invention to at least partially solve the problems in the conventional technology.

According to an aspect of the present invention, there is provided a data processing apparatus, including: a slide storage unit that sequentially stores input data; a search unit that searches for a data string, which is stored in the slide storage unit, matched with an input data string including the input data that is continuously input; a length generation unit that selects one from the data string searched by the search unit, obtains a length of the selected data string, and generates a length value; an address value generation unit that obtains a position, in the slide storage unit, of start data in the data string used to generate the length value by the length generation unit and generates an address value; a translation unit that translates a predetermined number of address values among address values having a high appearance frequency among address values generated by the address value generation unit into a translation address value having a value equal to or smaller than a predetermined value according to the appearance frequency of the address value; and an encoding unit that encodes the length value and the translation address value.

According to another aspect of the present invention, there is provided a data processing method, including: causing a slide storage unit to sequentially store input data; causing a search unit to search for a data string, which is stored in the slide storage unit, matched with an input data string including the input data that is continuously input; causing a length generation unit to select one from the data string searched in the causing the search unit to search, obtain a length of the selected data string, and generate a length value; causing an address value generation unit to obtain a position, in the slide storage unit, of start data in the data string used to generate the length value in the causing the length generation unit to generate, and generate an address value; causing a translation unit to translate a predetermined number of address values among address values having a high appearance frequency among address values generated in the causing the address value generation unit to generate into a translation address value having a value equal to or smaller than a predetermined value according to the appearance frequency of the address value; and causing an encoding unit to encode the length value and the translation address value.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example of configuration of a printer apparatus to which a data processing apparatus according to an embodiment of the invention is applicable;

FIG. 2 is a flowchart illustrating an overall process of a printer apparatus according to the present embodiment;

FIG. 3 is a block diagram illustrating an exemplary configuration of an encoder;

FIG. 4 is a diagram illustrating an example of a code format;

FIG. 5 is a diagram illustrates an encoding process according to the present embodiment;

FIG. 6 is a diagram illustrates a flag process in a slide search process and a list search process;

FIG. 7 is a diagram illustrates a flag process in a slide search process and a list search process;

FIGS. 8A to 8D are diagrams explaining a feature of program data of a machine language;

FIG. 9 is a diagram explaining a feature of program data of a machine language;

FIG. 10 is a diagram illustrating an example of a translation table ETRANSTABLE;

FIG. 11 is a flowchart illustrating an example of an overall flow of an encoding process according to the present embodiment;

FIG. 12 is a flowchart illustrating an example of a slide search process in further detail;

FIG. 13 is a flowchart illustrating an example of a list search process in further detail;

FIG. 14 is a flowchart illustrating an example of a slide addition process in further detail;

FIG. 15 is a flowchart illustrating an example of a slide encoding process in further detail;

FIG. 16 is a block diagram illustrating an exemplary configuration of an encoder in further detail;

FIG. 17 is a block diagram illustrating an exemplary hardware structure of a slide/list generation processing unit;

FIG. 18 is a block diagram illustrating an exemplary configuration of a decoder;

FIG. 19 is a diagram illustrating an example of an inverse translation table DTRANSTABLE;

FIG. 20 is a flowchart illustrating an exemplary process of decoding code data;

FIG. 21 is a block diagram illustrating an exemplary configuration of a decoder in further detail; and

FIG. 22 is a block diagram illustrating an exemplary hardware structure of a slide expanding unit.

### DETAILED DESCRIPTION OF THE PREFERRED EMBODIMENTS

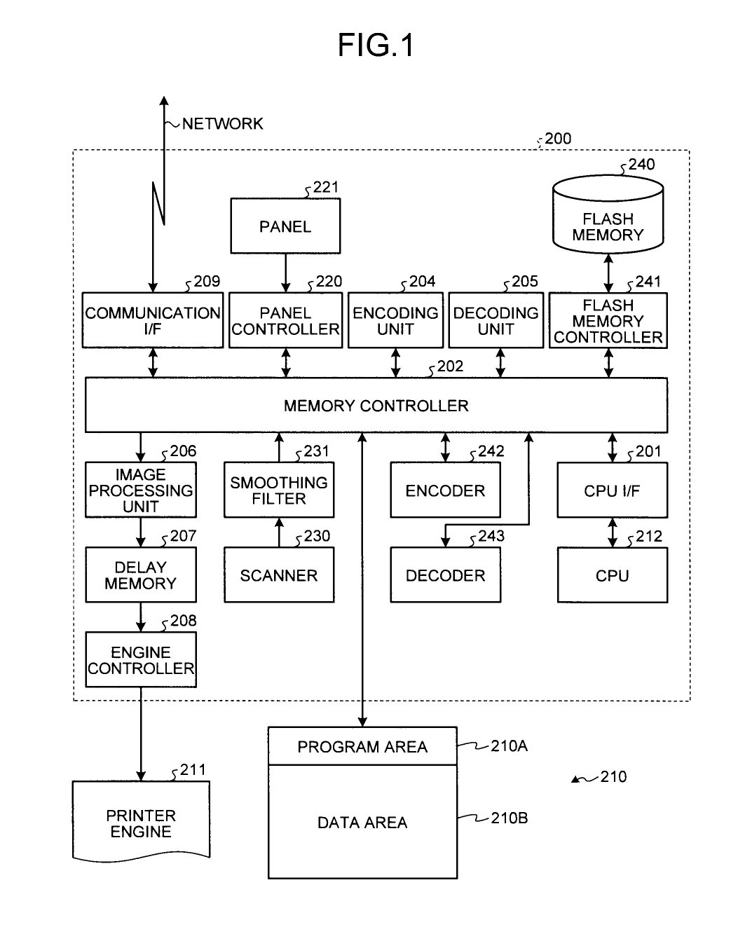

Hereinafter, exemplary embodiments of a data processing apparatus according to an embodiment of the invention will be described in detail with reference to the accompanying drawings. FIG. 1 illustrates an exemplary configuration of a printer apparatus to which a data processing apparatus according to the embodiment of the invention is applicable. In an example of FIG. 1, the printer apparatus includes a control unit 200, a main memory 210, a printer engine 211, and a flash memory 240 that is a non-volatile memory. The flash memory 240 may be built in the printer apparatus as in FIG. 1 or may be removably attached to the printer apparatus.

The control unit 200 includes a central processing unit 212, a CPU I/F 201, a memory controller 202, an encoding unit 204, a decoding unit 205, an image processing unit 206, a delay memory 207, an engine controller 208, a panel controller 220, a panel 221, a scanner 230, a smoothing filter 231, a flash memory controller 241, an encoder 242, and a decoder 243.

The CPU 212 controls an entire operation of the printer apparatus according to a program stored in the main memory 210. The CPU 212 is connected to the memory controller 202 through the CPU I/F 201. The memory controller 202 arbitrates access to the main memory 210 by the CPU 212, the encoding unit 204, the decoding unit 205, the image processing unit 206, a communication I/F 209, the smoothing filter 231, the flash memory controller 241, the encoder 242, and the decoder 243.

The main memory 210 is connected to the memory controller 202. The memory controller 202 controls access to the main memory 210.

The main memory 210 includes a program area 210A and a data area 210B. The program area 210A stores a program for operating the CPU 212. The data area 210B stores page description language (PDL) data supplied via a network, CMYK band data, code data in which band data is compression-encoded, and other data.

The encoding unit 204 encodes band data stored in the main memory 210. The encoded band data is supplied to the main memory 210 through the memory controller 202. The decoding unit 205 reads out encoding band data that is encoded by the encoding unit 204 and written in the main memory 210 from the main memory 210, and decodes the encoding band data in synchronization with the printer engine 211 which will be described later. The decoded band data is supplied to the image processing unit 206 through the memory controller 202. The image processing unit 206 performs a predetermined image process such as a gradation process on the band data supplied from the decoding unit 205.

The band data on which the image process has been performed is transmitted to the engine controller 208 through the delay memory 207. The delay memory 207 absorbs a difference between a transmission rate of band data output from the image processing unit 206 and a transmission rate of band data transmitted to the engine controller 208 to the printer engine 211.

The engine controller 208 controls the printer engine 211. In FIG. 1, only one among CMYK colors is illustrated as the printer engine 211, and the others are omitted for simplicity.

The communication I/F 209 controls communication to be performed via the network. For example, PDL data output from a computer connected to the network is received by the communication I/F 209. The communication I/F 209 transmits the received PDL data to the main memory 210 through the memory controller 202.

The network may be a type in which communications are performed within a predetermined range like a local area network (LAN) or a type in which communications are performed in a wider range like the Internet. The network is not limited to a wired communication network but may be of any type, for example, a wireless communication network or a serial communication according to such as universal serial bus (USB) or institute electrical and electronics engineers (IEEE) 1394.

A program executed on the CPU 212 and various data used in a corresponding program are compression-encoded by a compression coding scheme according to the present embodiment and stored in the flash memory 240. For example, program data, which is expanded as a code based on a machine language on the program area 210A of the main memory 210, is compression-encoded in the form of an expanded image and stored in the flash memory 240 as a snapshot. The flash memory controller 241 controls access to the flash memory 240.

The encoder 242 performs compression coding of the program data by a compression encoding scheme using a LZ77 code according to the present embodiment. The decoder 243 decodes data compression-encoded by a corresponding compression coding scheme.

An overall operation of the printer apparatus will schematically be described. For example, PDL data generated in a computer is received by the communication I/F 209 via a network and stored in the data area 210B of the main memory 210. The CPU 212 reads out the PDL data from the data area 210B of the main memory 210, analyzes the PDL data, and draws a CMYK band image based on the analysis result. CMYK band data derived from the drawn CMYK band image is stored in the data area 210B of the main memory 210.

The encoding unit 204 reads out the CMYK band data from the data area 210B and encodes the CMYK band data, for example, using a predictive coding scheme. Code data in which the CMYK band data is encoded is stored in the data area 210B of the main memory 210.

The decoding unit 205 reads out the code data in which the CMYK band data is encoded from the data area 210B of the main memory 210, decodes the code data, and supplies the decoded CMYK band data to the image processing unit 206 through the memory controller 202. The image processing unit 206 performs a predetermined image process on the CMYK band data supplied from the decoding unit 205. The CMYK band data on which the image process has been performed is supplied to the printer engine 211 through the delay memory 207 and the engine controller 208. The printer engine 211 performs a print-out operation based on the received CMYK band data.

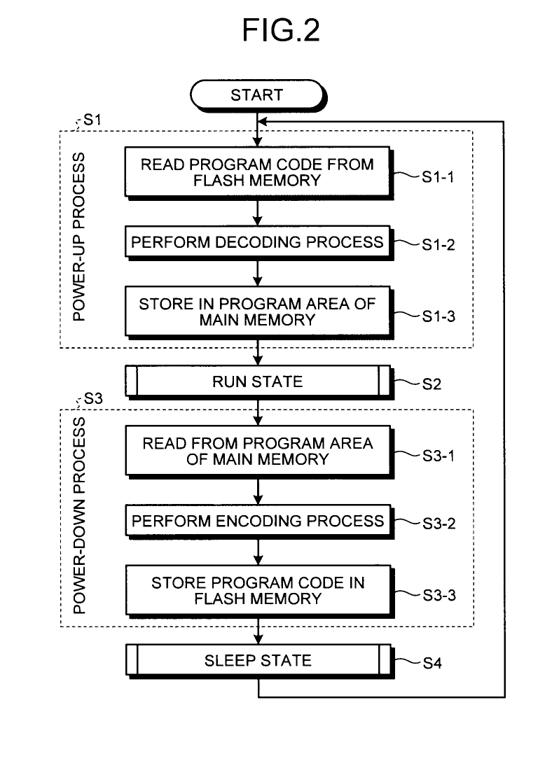

FIG. 2 is a flowchart illustrating an overall process of a printer apparatus according to the present embodiment. For example, when a user turns power of the printer apparatus on, a power-up process is performed (step S1), so that the printer apparatus enters a RUN state (an operation state) (step S2). If the user performs a power OFF operation, a power-down process is performed (step S3), and the printer apparatus enters a sleep state (step S4).

In the power-up process of step S1, program data that is compression-encoded and stored in the flash memory 240 as a snapshot is read out (step S1-1) and is decoded into program data based on a machine language by the decoder 243 according to a decoding scheme according to the present embodiment (step S1-2). The program data of the machine language is supplied to the main memory 210 through the memory controller 202 and stored in the program area 210A (step S1-3).

In the power-down process of step S3, the program data based on the machine language that is stored in the program area 210A of the main memory 210 is read out from the main memory 210 (step S3-1) and compression-encoded by the encoder 242 according to a coding scheme of the present embodiment (step S3-2). The program data that is compression-encoded is stored in the flash memory 240 as a snapshot (step S3-3).

As described above, at the time of the power-down process, the program data of the machine language that is stored in the program area 210A of the main memory 210 is compression-encoded in the form of an image on the memory and stored in the flash memory 240 as the snapshot. Therefore, the speed of the power-up process can increase.

<Encoder>

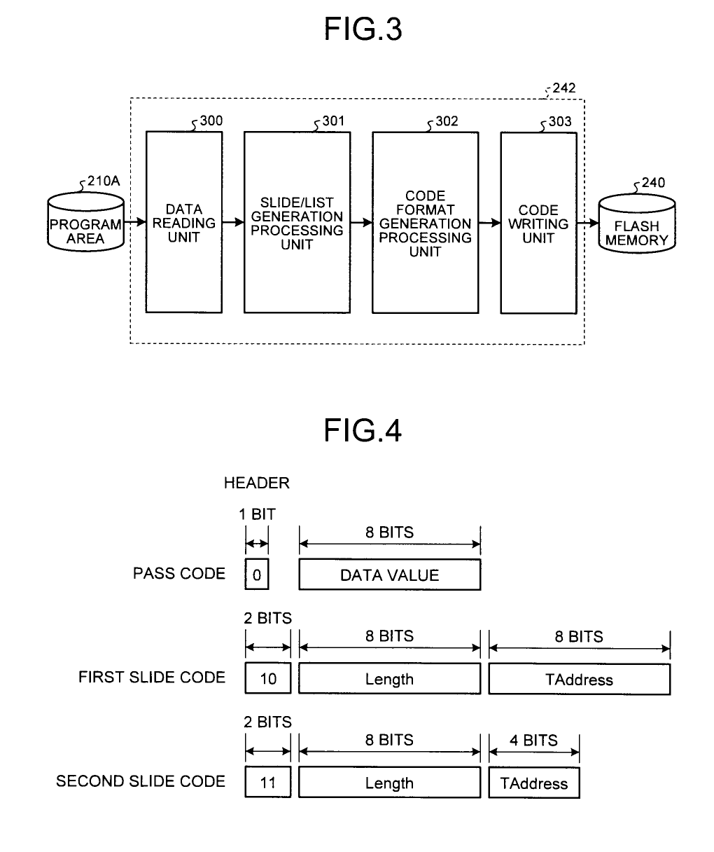

FIG. 3 illustrates an exemplary configuration of the encoder 242. In the encoder 242, a data reading unit 300 reads outs the program data of the machine language from the program area 210A of the main memory 210 through the memory controller 202. The data read by the data reading unit 300 is supplied to a slide/list generation processing unit 301.

The slide/list generation processing unit 301 includes a slide storage unit of a FIFO type that sequentially stores input data. The slide/list generation processing unit 301 sequentially compares received data with past input data stored in the slide storage unit. When the received data is matched with the past input data, the slide/list generation processing unit 301 holds an address value “Address” representing a position of the corresponding past input data in the slide storage unit and counts up a length “Length” as a value representing a matching length. However, when the received data does not match the past input data, the slide/list generation processing unit 301 encodes a data value into a PASS code. The slide/list generation processing unit 301 outputs the PASS code, the address value “Address”, the length “Length”, and a matching flag FLAG representing whether or not the received data matches the past input data.

In the present embodiment, the address value Address is translated into a translation address value TAddress by a rule which will be described later. The PAA code, the translation address value TAddress, the length “Length,” and a header representing a code type are output.

The values output from the slide/list generation processing unit 301 are supplied to a code format generation processing unit 302. The code format generation processing unit 302 encodes the PASS code, the address value Address, the length Length, and the header in a format illustrated in FIG. 4.

In FIG. 4, in the PASS code, a data value having a data length of eight (8) bits is attached to a header in which a data length is one (1) bit and a value is “0.” In a slide code, a length “Length” and an address value Address are sequentially attached to a header in which a data length is two (2) bits. The length “Length” has a code length of 8 bits.

In the present embodiment, the translation address value TAddress is encoded into any one of two types of code lengths selected according to its value. In the example of FIG. 4, the translation address value TAddress is encoded into any one of a code having a code length of 8 bits and a code having a code length of 4 bits. A slide code including the translation address value TAddress encoded into a code having a code length of 8 bits is referred to as a first slide code, and a header has a value of “10.” Further, a slide code including the translation address value TAddress encoded into a code having a code length of 4 bit is referred to as a second slide code, and a header has a value of “11.”

A code format illustrated in FIG. 4 is exemplary, and the invention is not limited thereto. For example, the code length of the translation address value TAddress is not limited to 8 bits or 4 bits in each of the first and second slide codes.

The PASS code and the first and second slide codes generated by the code format generation processing unit 302 are supplied to a code writing unit 303. The code writing unit 303 writes the received PASS code and the first and second slide code in the flash memory 240 through the memory controller 202 and the flash memory controller 241.

<Overview of Encoding Process>

Next, an encoding process in the slide/list generation processing unit 301 according to the present embodiment will be described. In the present embodiment, data encoding is performed by repeating a slide search process and a list search process using the LZ77 code. In the slide search process, past input data, stored in the slide storage unit, having a length of a predetermined unit matched with input data of one unit (for example, one byte) is searched. When no data matched with input data is searched from past input data in the slide storage unit, input data is used as the PASS code.

In the slide search process, if past input data in the slide storage unit matching the input data is found, the list search process is performed using the matched past input data as a root. In the list search process, a past input data string (called a list) in the slide storage unit matching an input data string continuously input after the root input data is searched.

In the list search process, when a list matching input data is no longer present, one of the previous lists just before that is selected and a position in the slide storage unit of the past input data that is the root of the selected list is output as the address value “Address,” and a length of that list is output as the length “Length.”

That is, the slide/list generation processing unit 301 generates past input data that becomes a root of the list search process in the slide search process. Further, the slide/list generation processing unit 301 performs growth and selection of lists based on the root and then performs encoding based on a finally remaining list.

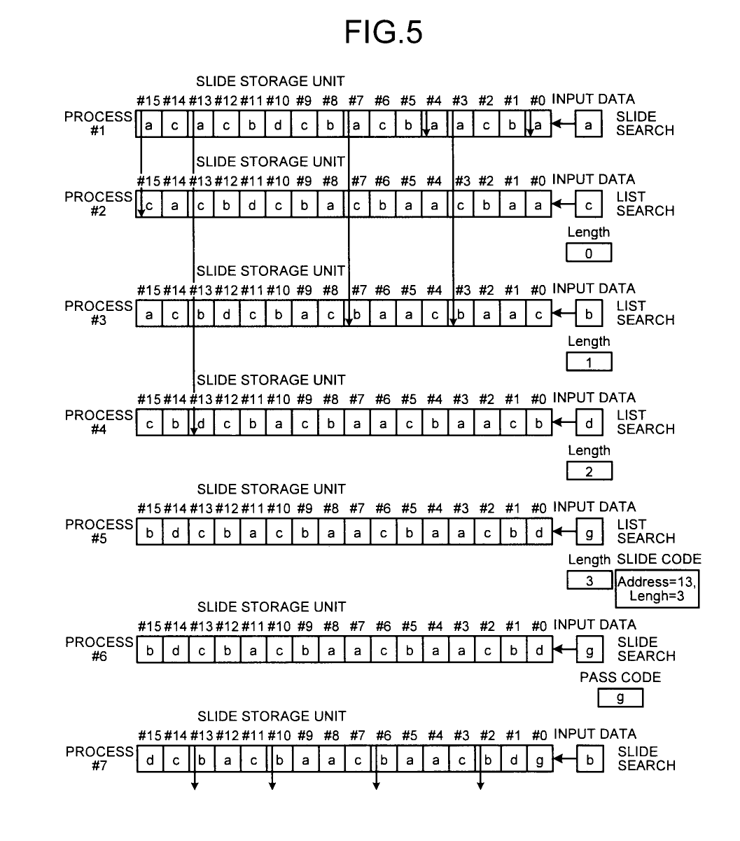

A further detailed description will be given with reference to FIG. 5. In an example of FIG. 5, the slide storage unit includes 16 registers which are connected in series as designated by #0 to #15 and has a FIFO configuration. Each register is configured to store data of one unit (for example, one byte). Hereinafter, a register included in the slide storage unit is referred to as “slide.”

In a process #1, 16 past input data “a, b, c, a, a, b, c, a, b, c, d, b, c, a, c, a” have been already input in the slides of the slide storage unit, respectively, in an order in which an input is new, that is, from the right-hand side to the left-hand side in FIG. 5. First, input data “a” is input to the slide/list generation processing unit 301. In the slide search process, the input data “a” is compared with each of the past input data stored in the slides to search for matching data. In the example of FIG. 5, data stored in the slides #0, #3, #4, #7, #13, and #15 match the input data. Therefore, data stored in the slides having these numbers become roots in the list search process.

Since data matching the input data “a” is found from the past input data stored in the slides by the slide search process, a list search process of a process #2 is performed.

In the process #2, the past input data stored in each of the slides are slid to the left by one, and the input data “a” input in the process #1 is added to the slide #0 of the slide storage unit. Further, next input data “c” is input to the slide/list generation processing unit 301. In the list search process, of the past input data stored in each of the slides, data matching the new input data “c” is searched from each of the slides in which the past input data that matched the input data were stored in the previous process #1 just before the process #2.

In the example of FIG. 5, the past input data stored in the slides #0 and #4 that matched the input data in the process #1 do not match the input data in the process #2. The past input data stored in the slides #3, #7, #13, and #15 that matched the input data in the process #1 is data “c” and thus matches the new input data “c.”

Since data matching the input data “c” in the process #2 are found by the list search process of the process #2 from each of the slides which store the past input data that matched the input data in the previous process #1 just before the process #2, the next process is a list search process. Since the process #2 is a starting point of the list search process, the length “Length” representing a list length has a value of “0.”

In the process #3, similarly to the above-describe process #2, the past input data stored in each of the slides is slid by one, and the input data “c” input in the process #2 is added to the slide #0 of the slide storage unit. Further, next input data “b” is input to the slide/list generation processing unit 301. Of the past input data stored in each of the slides, data matching the new input data “b” is searched from each of the slides in which the past input data that matched the new input data were stored in the previous process #2 immediately before the process #3.

In the example of FIG. 5, the past input data stored in the slide #15 searched in the process #2 does not match the input data in the process #3. The past input data in the process #3 stored in the slides #3, #7, and #13 searched in the process #2 are data “b” and thus match the new input data “b.” In a next process #4, the past input data stored in the slides #3, #7, and #13 become a list search target. That is, in the process #3, lists relative to the slides #3, #7, and #13 remain. In the process #3, a list length is “1,” and thus the length “Length” has a value of “1.”

The above-described processes are repeated to obtain a data string with a longest list. In the example of FIG. 5, in a process #5, past input data “c” stored in the slide #13 list-searched in the previous process #4 just before the process #5 does not match new input data “g,” and thus the list is broken. In the process #5, one of the lists remaining in the previous process #4 just before the process #5 is selected and encoding into a slide code is performed with a position (number) of that slide in the slide storage unit being the address value “Address”, and a length of the list being the length “Length”. In the example of FIG. 5, the address value “Address” is “13,” and the length “Length” is “3.”

In the process #5, the slide search process is performed on input data “g.” In this example, since data “g” is not stored as the past input data in any of the slide, there is no matching data. In this case, the process proceeds to a process #6, and the input data “g” is used “as is” to be encoded into a PASS code.

When encoding into the PASS code is performed, in the process #7, past input data stored in each of the slides is slid by one, and the input data “g” input in the previous list search process (the process #5) is added to the slide #0 of the slide storage unit. The slide search process is performed on next input data “b.”

The slide storage unit is able to slide the data stored in each slide by the FIFO method and thus to proceed to processing of next input data while maintaining the list for which matching with input data has been stored “as is.”

For example, in the example of FIG. 5, in the process #1, the input data matches the past input data stored in the slides #0, #3, #4, #7, #13, and #15. By sequentially sliding the data stored in each of the slides as new data is input, next data is stored in the slides #0, #3, #4, #7, #13, and #15 in the process #2. Therefore, in the slide storage unit, the data stored in the slide having the number which was found to match in the slide search process is compared with the input data in each list search process, whereby a data string of the past input data matching a data string of the input data is searchable.

Since the slide storage unit employs the FIFO method as described above, the list search process is able to be easily performed.

Further, according to the above-described process, if there is no list matching the input data in the list search process and the process proceeds from the list search process to the slide search process, a time period is generated during which encoding does not progress and which is worth one process. That is, when one process is to be performed in one clock, one clock is wasted when shifting from the list search process to the slide search process.

<Flag Process>

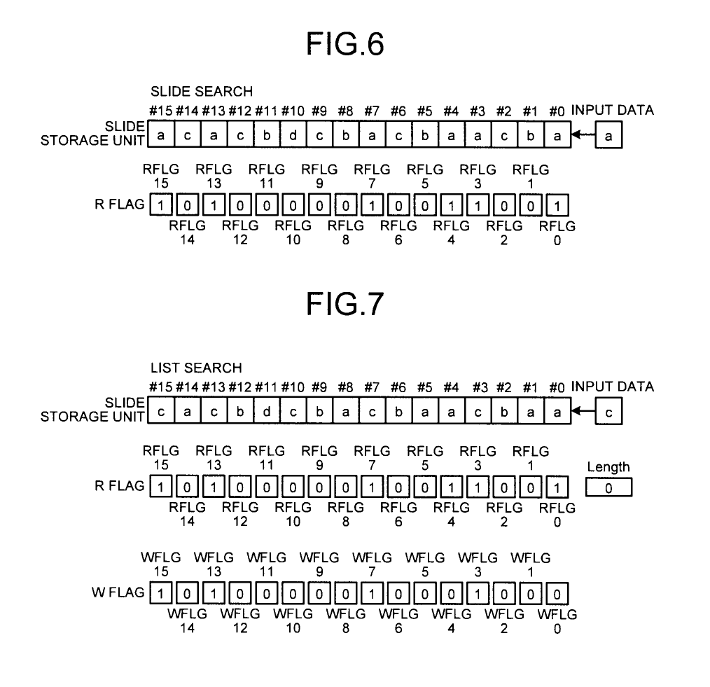

The slide search process and the list search process are controlled by a flag. A flag process in the slide search process and the list search process will be described with reference to FIGS. 6 and 7.

FIG. 6 illustrates an R flag RFLGm representing a result of the slide search process. As illustrated in FIG. 6, when input data “a” is input in a state in which past input data “a, b, c, a, a, b, c, a, b, c, d, b, c, a, c, a” are stored in the slides of the slide storage unit from right to left in the drawing, the past input data stored in the slides #0, #3, #4, #13, and #15 match the input data. Therefore, R flags RFLG0, RFLG3, RFLG4, RFLG7, RFLG13, and RFLG15, which correspond to the slides having these numbers, are set to a value of “1” representing a match, respectively.

When input data matches the past input data stored in the slides, the list search process is performed instead of an encoding process. At this time, a position of the R flag RFLGm relative to each slide is fixed. When the past input data stored in the slides do not match the input data, the input data is used “as is” to be encoded into a PASS code, and the slide search process is performed on next input data.

FIG. 7 illustrates an example of a W flag WFLGm representing a result of the list search process. In the list search process, data matching input data newly input is searched from the data stored in the slides for which the R flag RFLGm has been set to “1” of the slides. If matching data is found, a value of the W flag WFLGm for the corresponding slide is set to a value of “1” representing a match.

In the example of FIG. 7, the list search process is performed on the data stored in the slides #0, #3, #4, #7, #13, and #15 for which each value of the R flag RFLGm has been set to “1” of the past input data stored in the slides. Since the data stored in the slides #3, #7, #13, and #15 match input data “c,” values of corresponding W flags WFLG3, WFLG7, WFLG13 and WFLG15 are set to a value “1” representing a match. Of the past input data stored in each of the slides, the data stored in the slides for which the value of the W flag WFLGm has been set to “1” indicate that the past input data stored in the slides matching the previously input data input immediately before is strung with the past input data matching the presently input data.

Next, the W flag WFLGm having a value of “1” is searched. When the W flag WFLGm having a value of “1” is present, the list search process is performed on next input data in the same manner as described above using each W flag WFLGm as a new R flag RFLGm.

If the W flag WFLGm having a value of “1” is not present as a result of the search, it means that the list has come to an end. In this case, one R flag RFLGm having a value of “1” is selected. An address value “Address” of the slide corresponding to the selected R flag RFLGm and the length “Length” at that time are encoded into the slide code.

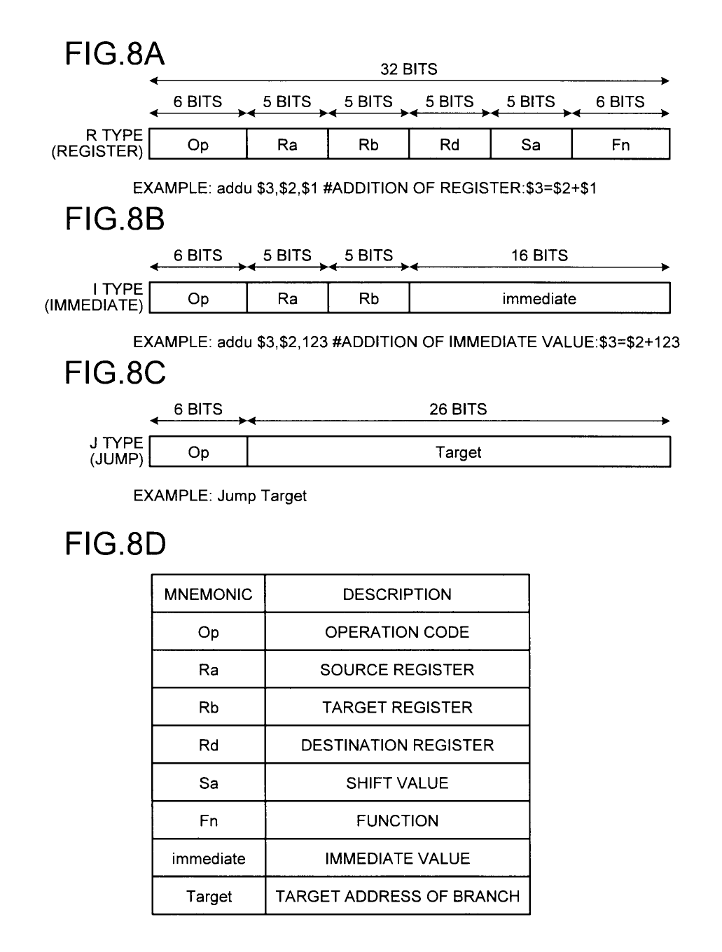

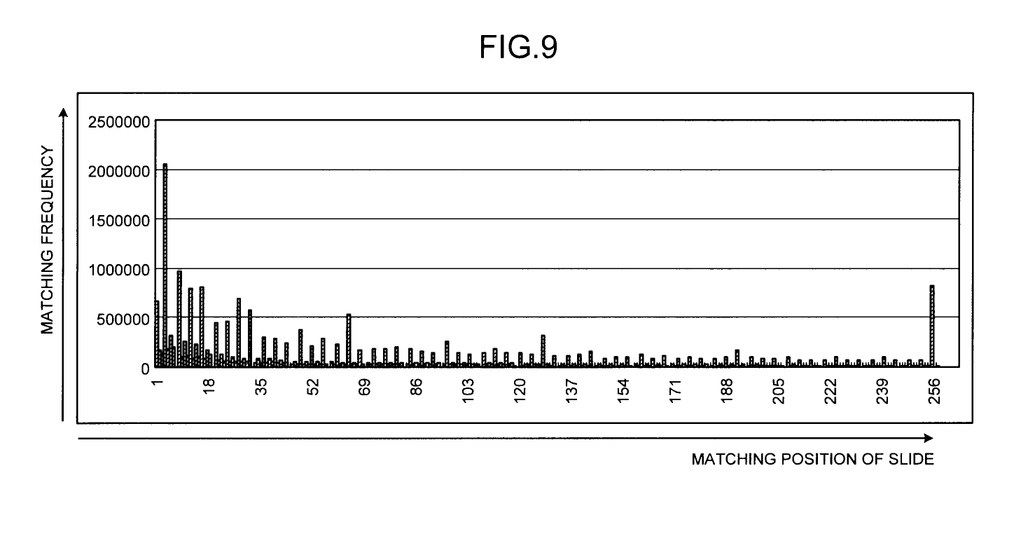

A feature of the program data of the machine language will schematically be explained with reference to FIGS. 8A to 8D and 9. FIGS. 8A to 8D illustrate an example of a command format in a machine language program on the CPU based on the RISC technique. FIG. 8A illustrates an example of an R (register) type command, FIG. 8B illustrates an example of an I (immediate) type command, and FIG. 8C illustrates an example of a J (jump) type command. In each command, 32 bits are divided into predetermined division areas to store predetermined mnemonics. FIG. 8D illustrates meaning of the mnemonics.

Among the mnemonics, a mnemonic (Op) representing an operation code is fixedly stored in a front area of 6 bits in each of the R type command, the I type command, and the J type command. In the RISC, since the code having the same meaning is stored in a predetermined area decided in a fixed format having a data length of 32 bits, a possibility that the sides will be matched every 4 bytes (32 bits) or 8 bytes increases.

FIG. 9 illustrates an example of a statistical result on a matching position of the slide in the program data of the machine language. In FIG. 9, a horizontal axis denotes a matching position (the address value Address) of the slide, and a vertical axis denotes a matching frequency (an appearance frequency). According to the statistical result illustrated in FIG. 9, a peak having a high matching frequency appears every 4 bytes. Observing an overall change in which the peaks of every 4 bytes are excluded, it can be seen that a probability that the slides will be matched increase as the matching position is closer. Further, it can be seen that if the matching position of the slide is at some distance, it is converged to a low matching probability.

In the present embodiment, coding of the slide code is performed using the fact that in the program data of the machine language described above, a peak of a slide matching probability appears every 4 bytes.

Specifically, the address values Address of the slide code are sorted in an order that the matching frequency of the slide is high, and the translation address values TAddress having a value representing the sorted order are generated. A predetermined number of translation address values TAddress that can be expressed by 4 bytes, that is, the translation address values TAddress having a value between “0” and “15” are encoded into codes having a code length of 4 bits. The second slide code is formed by the translation address value TAddress encoded into the code having the code length of 4 bytes. Meanwhile, the translation address values TAddress having a value between “15” and “255” are encoded into codes having a code length of 8 bytes. The first slide code is formed by the translation address value TAddress encoded into the code having the code length of 8 bytes.

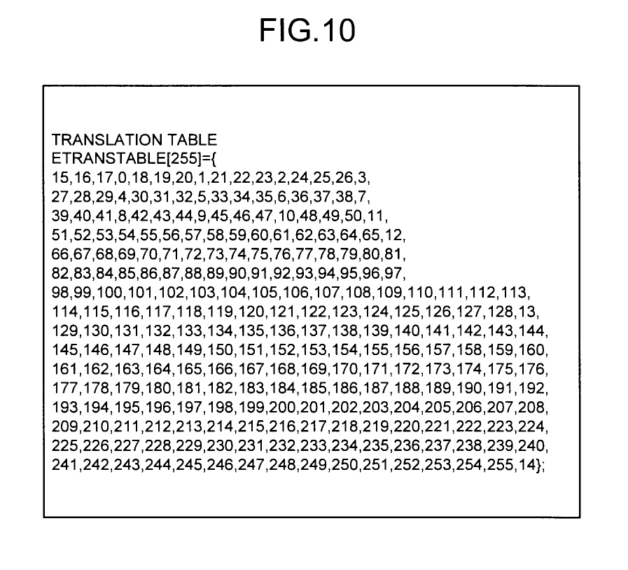

In order to translate the address value Address into the translation address value TAddress, for example, a translation table ETRANSTABLE illustrated in FIG. 10 may be used. Numbers enumerated in the translation table ETRANSTABLE represent the translation address values TAddress after translation. A value (that starts from “0”) representing an order of the numbers enumerated in the translation table ETRANSTABLE represents the address value Address before translation. That is, when the address value Address is input to the translation table ETRANSTABLE, a value of a position corresponding to the input address value Address is output as the translation address value TAddress.

In the translation table ETRANSTABLE, as can be seen in FIG. 10, the translation address value TAddress having a small value is assigned every 4 address values Address. That is, according to the statistical result of FIG. 9, the translation address value TAddress having a small value is assigned every 4 bytes of the program data in units of bytes. Further, according the statistical result of FIG. 9, if the matching position of the slide is at some distance, it is converged into a value having a small matching frequency. Thus, as the value is closer to the rear of the translation table ETRANSTABLE, the regularity of the translation address value TAddress becomes weaker, excluding the last value (that is, the address value Address “255”).

In the front part of the translation table ETRANSTABLE, the translation address value TAddress “15” is assigned to the address value Address “0.” This is because as described above with reference to FIG. 9, as the matching position of the slide is closer, the matching frequency is high, which is the general feature of the statistical result.

Specifically, in the translation table ETRANSTABLE, the address value Address “3” before translation is translated into the translation address value TAddress “0.” Further, the address value Address “0” before translation is translated into the translation address value TAddress “15.” Similarly, the address value Address “11” before translation is translated into the translation address value TAddress “2.”

As described above, all of the translation address values TAddress having a value between “0” to “15” are translated into the codes having the code length of 4 bytes. For this reason, in the translation table ETRANSTABLE, an order of the address values Address that are associated with the translation address values TAddress “0” to “15” can be actually changed. Similarly, an order of the address values Address that are associated with the translation address values TAddress “16” to “255” can be changed.

Here, the above description has been made in connection with the example of the translation table ETRANSTABLE in which an order of the translation address values TAddress in which the translation address values TAddress are enumerated represents an original address value Address, but the invention is not limited to the above example. For example, the translation table may be configured such that the address value Address before translation and the translation address value TAddress after translation have a one-to-one correspondence relationship.

Further, the translation address value TAddress having a small value is assigned every 4 bytes, but the invention is not limited to the above example. That is, a unit in which the translation address value TAddress having a small value is assigned may be set according to the command format of the program data. For example, the command format has a data length of 64 bits, the translation address value TAddress having a small value may be assigned every 8 bytes.

<Details of Encoding Process>

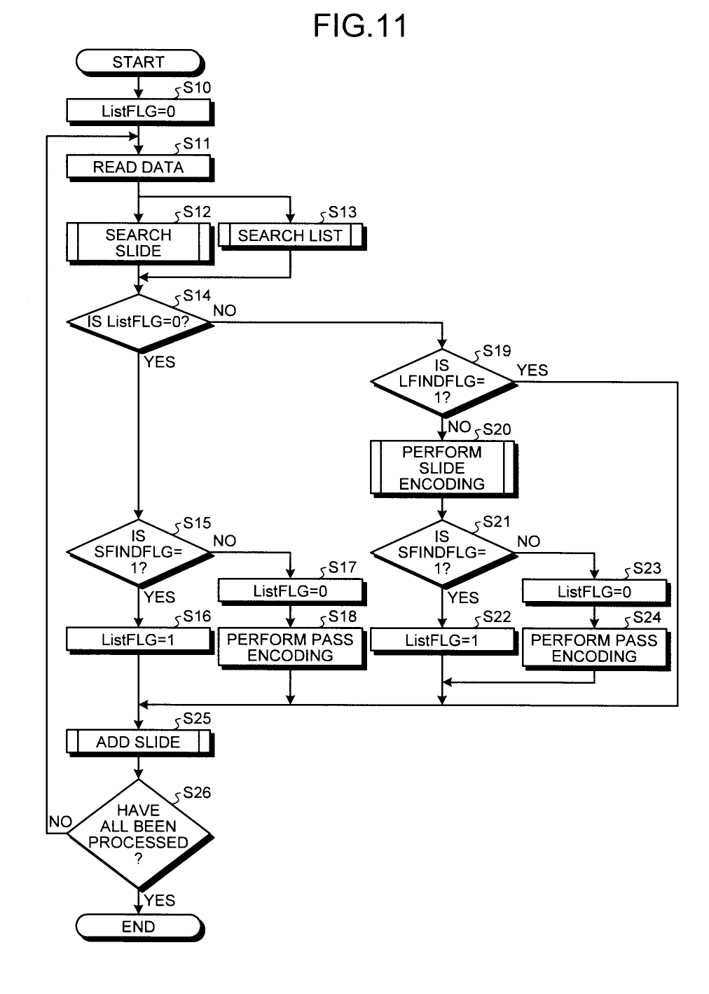

Next, an encoding process in the slide/list generation processing unit 301 will be described in further detail. FIG. 11 is a flowchart illustrating an example of an overall flow of an encoding process according to the present embodiment. It is assumed that before the process of the flowchart of FIG. 11, the data reading unit 300 retains data of a certain length in advance as process target data.

In step S10, the slide/list generation processing unit 301 initializes a flag ListFLG representing which of the slide search process and the list search process is effective to a value “0” representing that the slide search process is being performed. Next, in step S11, the slide/list generation processing unit 301 reads data of one unit from the data reading unit 300 as input data. The read input data is stored in the slide storage unit.

When the input data is stored in the slide storage unit, in step S12, the slide search process is performed on the data of one unit, and in step S13, the list search process is performed on the data of one unit. As will be described later in further detail, in the present embodiment, a slide search unit that performs the slide search process and a list search unit that performs the list search process are separately configured, and thus the processes of step S12 and step S13 are able to be performed in parallel.

The process proceeds to step S14, and the slide/list generation processing unit 301 determines whether or not the value of the flag ListFLG is “0.” When it is determined to be “0,” the slide search process is presently effective, and the process proceeds to step S15. In step S15, it is determined whether or not a value of a flag SFINDFLG is “1.” When it is “1,” it is determined that past input data matching the input data was found in a slide storage unit 101, and thus in step S16, the value of the flag ListFLG is set to “1” representing that the list search process is effective.

Then, the process proceeds to step S25, and the input data is added to the slide storage unit. In step S26, it is determined whether or not processing on all of process target data has been completed. When it is determined as not completed, the process returns to step S11, and next data of one unit is read in as input data. However, when it is determined as completed, the series of encoding processes are ended.

Meanwhile, when it is determined in step S15 that the value of the flag SFINDFLG is “0,” it is determined that past input data matching the input data was not found in the slide storage unit 101, and the process proceeds to step S17. In step S17, the value of the flag ListFLG is set to “0,” to set the slide search process as effective. In step S18, the input data is encoded into the PASS code. Further, the value of the matching flag FLAG is set to “0,” and the process proceeds to step S25.

When it is determined in step S14 that the value of the flag ListFLG is not “0” but “1,” it is determined that the list search process is presently effective, and the process proceeds to step S19. In step S19, it is determined whether or not the value of the flag LFINDFLG is “1.” When it is determined to be “1,” the process proceeds to step S25.

When it is determined in step S19 that the value of the flag LFINDFLG is not “1,” that is, the value of the flag LFINDFLG is “0,” the process proceeds to step S20. In step S20, the address value Address is translated into the translation address value TAddress according to ETRANSTABLE, and the translation address value TAddress, the length Length, and the header are encoded into the first or second slide code illustrated in FIG. 4. Then, the process proceeds to step S21, and it is determined whether or not the value of the flag SFINDFLG is “1.” When it is determined as “1,” it is determined that the list is continued in the list search process, and the process proceeds to step S22. The value of the flag ListFLG is set to “1,” and the process proceeds to step S25.

When it is determined in step S20 that the value of the flag SFINDFLG is “0,” it is determined that the list has broken in the list search process, and the process proceeds to step S23. The value of the flag ListFLG is set to “0.” In step S24, the input data is encoded into a PASS code “as is” and stored in a register 141. The process proceeds to step S25.

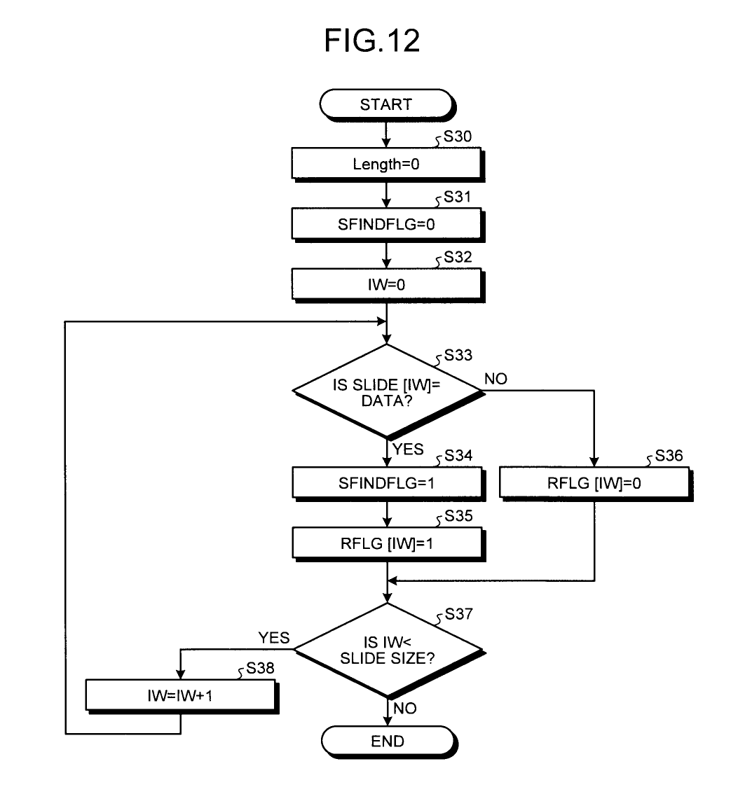

FIG. 12 is a flowchart illustrating an example of the slide search process in step S12 of FIG. 11 in further detail. In FIGS. 12, 13, and 14, the slides in the slide storage unit are each represented as slide [x] to include the slide number. Further, a head slide in the slide storage unit having a FIFO configuration is designated as slide [0].

First, in step S30 to step S32, the length Length, the flag SFINDFLG, and a variable IW are initialized to a value of “0,” respectively. The process proceeds to step S33, and it is determined whether or not input data is matched with past input data stored in a slide [IW]. When it is determined as matched, the process proceeds to step S34, and the value of the flag SFINDFLG is set to “1,” and in step S35, the value of the R flag RFLG[IW] is set to “1.”

Then, the process proceeds to step S37, and it is determined whether or not the variable IW is less than the slide size, that is, the number of slides included in the slide storage unit. When it is determined that the variable IW is less than the slide size, in step S38, “1” is added to the variable IW, and the process returns to step S33. When it is determined that the variable IW is equal to or greater than the slide size, a series of processes are ended.

Meanwhile, when it is determined in step S33 that the input data does not match the past input data stored in the slide [IW], the process proceeds to step S36, and the value of the R flag RFLG[IW] is set to “0.” Then, the process proceeds to step S37.

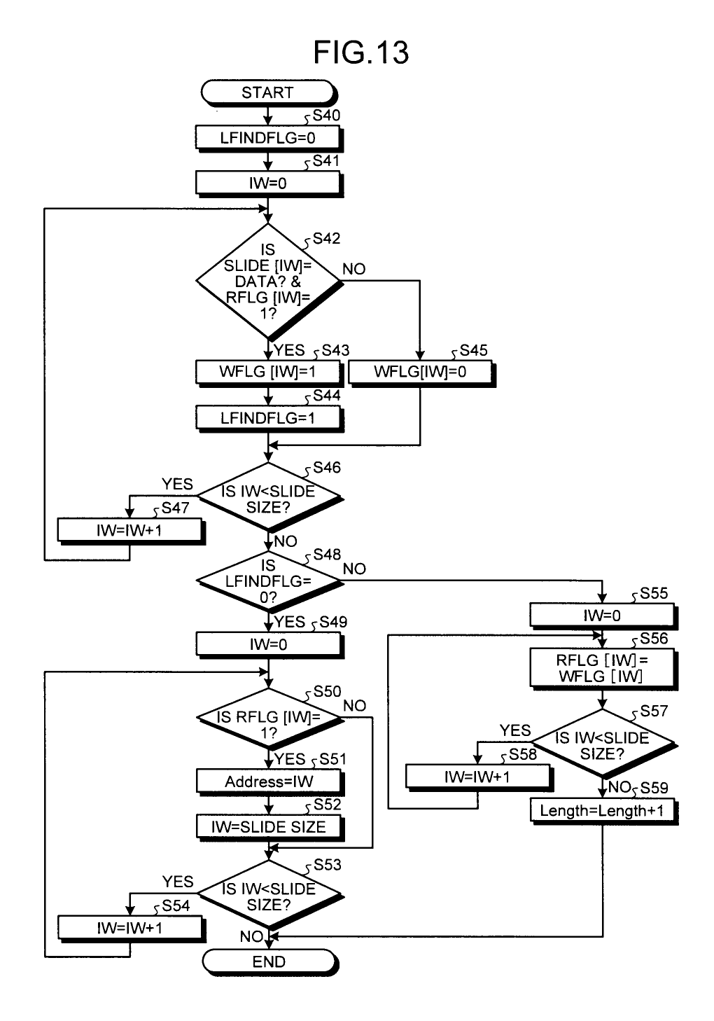

FIG. 13 is a flowchart illustrating an example of the list search process in step S13 of FIG. 11 in further detail. First, in step S40 and step S41, the flag LFINDFLG and the variable IW are each initialized to a value “0”.

In step S42, it is determined whether or not input data is matches the past input data stored in the slide [IW] and the value of the R flag RFLG[IW] is “1.” When it is determined that these two conditions are satisfied, the process proceeds to step S43, and the value of the W flag WFLG[IW] is set to “1.” In step S44, the value of the flag LFINDFLG is set to “1.” Then, the process proceeds to step S46.

Meanwhile, in step S42, when it is determined that the above-described condition is not satisfied, that is, the input data is not matched with the past input data stored in the slide [IW] and/or the value of the R flag RFLG[IW] is not “1,” the process proceeds to step S45, and the value of the W flag WFLG[IW] is set to “0”. Then, the process proceeds to step S46.

In step S46, it is determined whether or not the variable IW is less than the slide size. When it is determined that the variable IW is less than the slide size, in step S47, “1” is added to the variable IW, and the process returns to step S42. Meanwhile, when it is determined that the variable IW is equal to or more than the slide size, the process proceeds to step S48.

In step S48, it is determined whether or not the value of the flag LFINDFLG is “0.” When it is determined that the value is “0,” the process proceeds to step S49, and the variable IW is initialized to a value of “0.” In step S50, it is determined whether or not the value of the R flag RFLG[IW] is “1.” When it is determined to be “1,” the process proceeds to step S51.

In step S51, the variable IW is set to the address value “Address,” and in step S52, the slide size is assigned to the variable IW. Then, the process proceeds to step S53. In step S53, it is determined whether or not the variable IW is less than the slide size. When it is determined that the variable IW is less than the slide size, in step S54, “1” is added to the variable IW, and the process returns to step S50.

When it is determined in step S53 that the variable IW is equal to or greater than the slide size, a series of processes are ended. For example, when the process proceeds to step S53 via step S52, since in step S52, the slide size has been substituted into the variable IW, the process is inevitably finished.

When it is determined in step S48 that the value of the flag LFINDFLG is not “0,” the process proceeds to step S55, and the variable IW is initialized to a value of “0.” In step S56, the W flag WFLG[IW] is set with respect to the R flag RFLG[IW]. In step S57, it is determined whether or not the variable IW is less than the slide size. When it is determined that the variable IW is less than the slide size, in step S58, “1” is added to the variable IW, and the process returns to step S56. Meanwhile, when it is determined in step S57 that the variable IW is equal to or greater than the slide size, the process proceeds to step S59, and “1” is added to the length “Length.” Then, a series of processes are ended.

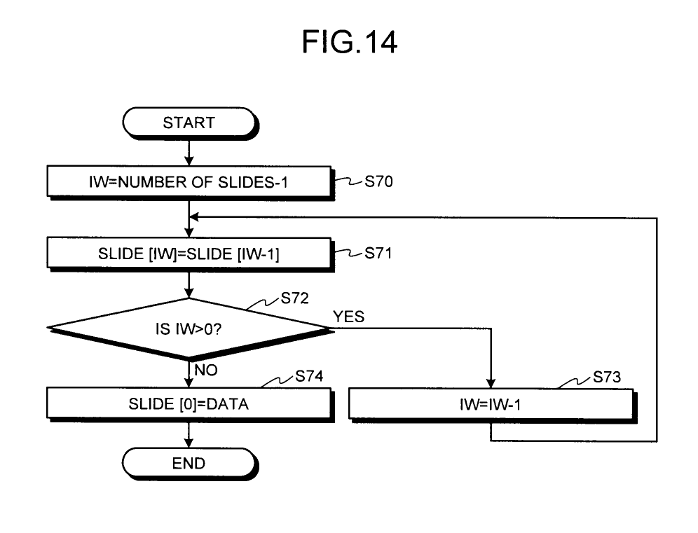

FIG. 14 is a flowchart illustrating an example of a slide adding process in step S25 of FIG. 11 in further detail. First, in step S70, a value obtained by subtracting “1” from the number of slides is set to the variable IW. In step S71, the value of the slide [IW−1] is stored in the slide [IW]. In step S72, it is determined whether or not the variable IW exceeds “0.” When it is determined that the variable IW exceeds “0,” the process proceeds to step S73, and “1” is subtracted from the variable IW. Then, the process returns to step S71. Meanwhile, when it is determined in step S72 that the variable IW is less than “0,” the process proceeds to step S74, and input data is stored in the slide [0].

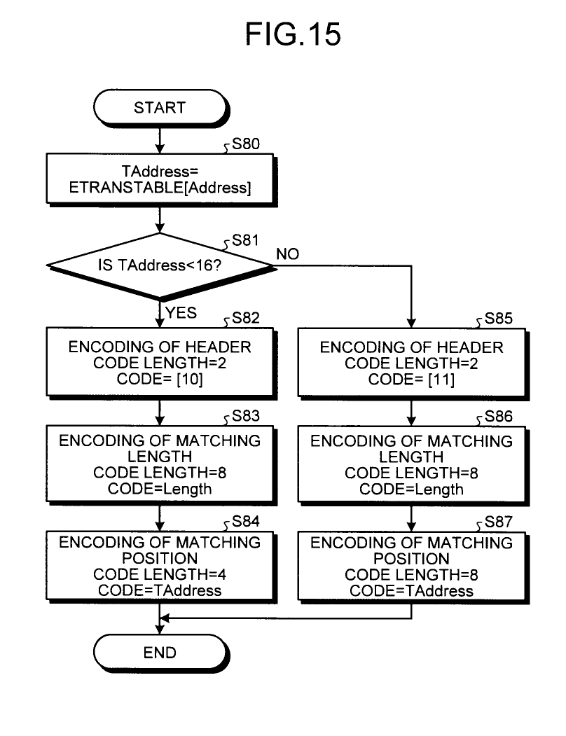

FIG. 15 illustrates an example of the slide encoding process in step S20 of FIG. 11 in further detail. The code format conforms to the format illustrated in FIG. 4. First, in step S80, the address value Address is translated into the translation address value TAddress by the translation table ETRANSTABLE. Next, in step S81, it is determined whether or not the value of the translation address value TAddress is smaller than “16.” Here, it is assumed that the value of the translation address value TAddress starts from “0.”

If it is determined that the value of the translation address value TAddress is smaller than “16,” the process proceeds to step S82, and the header is encoded. In this example, the header is encoded into a code having a code length of 2 bits and a value of “10.” After the header is encoded, in step S83, the matching length, that is, the length Length is encoded. In this example, the length Length is encoded into a code having a code length of 8 bits. In step S84, the matching position, that is, the translation address value TAddress is encoded. Since the translation address value TAddress has a value smaller than “16,” the translation address value TAddress is encoded into a code having a code length of 4 bits.

If it is determined that the value of the translation address value TAddress is equal to or more than “16,” the process proceeds to step S85, and the header is encoded. In this example, the header is encoded into a code having a code length of 2 bits and a value of “11.” After the header is encoded, in step S86, the matching length, that is, the length Length is encoded. In this example, the length Length is encoded into a code having a code length of 8 bits. In step S87, the matching position, that is, the translation address value TAddress is encoded. Since the translation address value TAddress has a value equal to or more than “16,” the translation address value TAddress is encoded into a code having a code length of 8 bits.

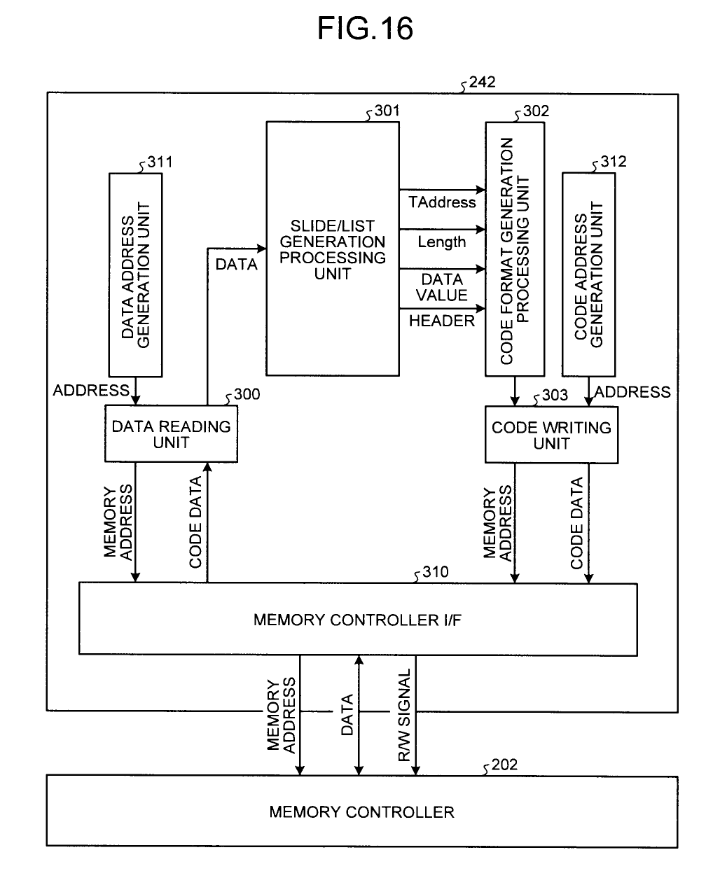

FIG. 16 illustrates an exemplary configuration of the encoder 242 in further detail. In FIG. 16, the same parts as in FIG. 3 are denoted with the same reference numerals, and thus a description thereof will not be repeated. The encoder 242 includes the data reading unit 300, the slide/list generation processing unit 301, the code format generation processing unit 302, the code writing unit 303, a memory controller I/F 310, a data address generation unit 311, and a code address generation unit 312.

The data address generation unit 311 generates a memory address for reading out the program data from the program area 210A of the main memory 210. The data reading unit 300 requests the memory controller 202 to read out data from the memory address generated by the data address generation unit 311 through the memory controller I/F 310. At the request, the program data read out from the program area 210A of the main memory 210 by the memory controller 202 is supplied from the memory controller 202 to the encoder 242. The program data is supplied to the data reading unit 300 through the memory controller I/F 310. The data reading unit 300 supplies the slide/list generation processing unit 301 with the received program data.

The slide/list generation processing unit 301 generates the address value Address, the length Length, the PASS code, and the header from the received program data as described above. The address value Address is translated into the translation address value TAddress by the translation table ETRANSTABLE. The translation address value TAddress, the length Length, the PASS code (the data value), and the header are supplied to the code format generation processing unit 302. The code format generation processing unit 302 generates the PASS code, the first slide code, and the second slide code from the received values according to the code format illustrated in FIG. 4. The generated PASS code, the first slide code, and the second slide code are supplied to the code writing unit 303.

The code writing unit 303 supplies the memory controller 202 with the received PASS code, the first slide code, and the second slide code through the memory controller I/F 310. Further, the code writing unit 303 requests the memory controller 202 to write the codes in the flash memory 240 according to the memory address generated by the code address generation unit 312 through the memory controller I/F 310. At the request, the memory controller 202 writes the received codes in the flash memory 240 through the flash memory controller 241.

<A Hardware Configuration Example of the Slide/List Generation Processing Unit>

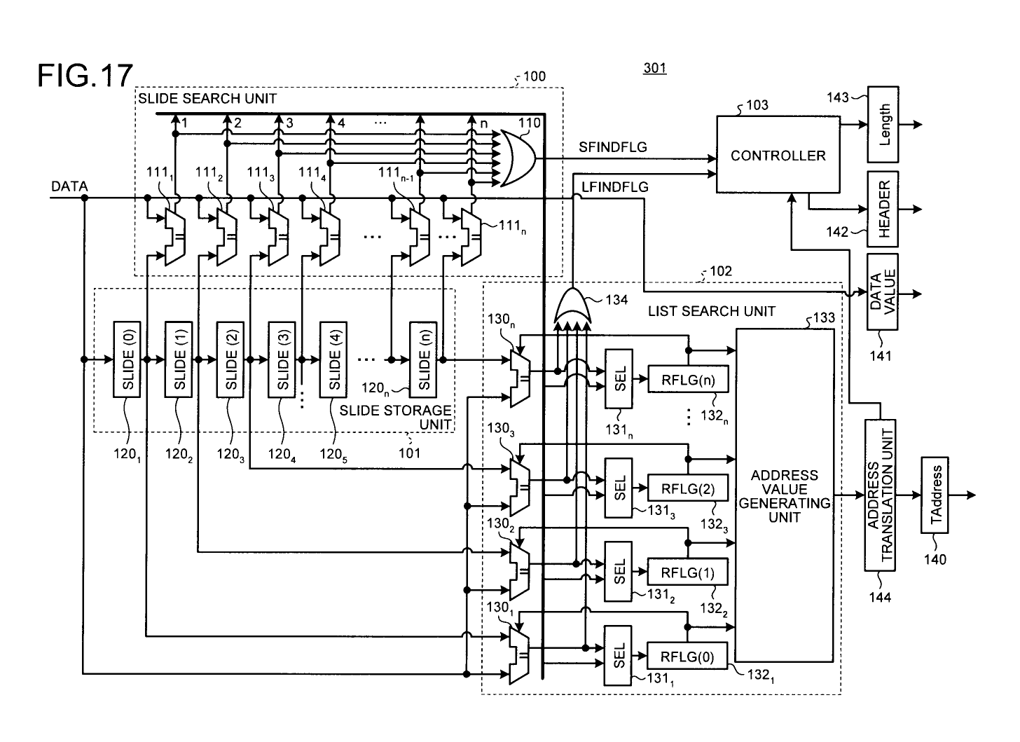

FIG. 17 illustrates an example of a hardware configuration of the slide/list generation processing unit 301 that performs the slide search process, the list search process, and the encoding process which are described above. The slide/list generation processing unit 301 includes a slide search unit 100, the slide storage unit 101, a list search unit 102, and a controller 103.

The controller 103 includes, for example, a microprocessor and performs the processes of step S11 to step S26, excluding step S12 and step S13, described with reference to the flowchart of FIG. 11 to control an operation of the slide/list generation processing unit 301. For example, the controller 103 performs operation control based on the flag ListFLG representing which of the present slide search process and the list search process is effective.

For example, input data of one unit is input per clock to the slide/list generation processing unit 301 and supplied to each of the slide search unit 100, the slide storage unit 101, and the list search unit 102. The input data is also stored in the register 141 at an output side. The input data stored in the register 141 is used as a data value for the encoding of the PASS code. Hereinafter, one byte is used as one unit of data.

The slide storage unit 101 includes n (for example, 256) slides 120₁, 120₂, . . . , and 120ₙ, which are connected in series. Each slide includes a register and stores data of one unit. An output of each of the slides 120₁, 120₂, . . . , and 120ₙ is supplied to a next register and also supplied to one of input terminals of a comparator 111m of the slide search unit 100 which will be described later and one of input terminals of a comparator 130ₘ of the list search unit 102, respectively.

The comparator 130ₘ represents an arbitrary one of the comparators 130₁ to 130ₙ. This notation is commonly applied in the comparators 111₁ to 111ₙ, the selectors 131₁ to 131ₙ, and the registers 132₁ to 132ₙ.

Further, the data length of the address value Address and the length Length are decided according to the number n of slides included in the slide storage unit 101. If the number n of the slides is 256, the data length is decided as 8 bits so that the address value Address and the length Length can have a value of up to 256.

In the slide storage unit 101, a FIFO configuration is formed with the n slides 120₁, 120₂, . . . , and 120ₙ, and input data is sequentially transmitted from the slide 120₁ to the slide 120₂, then to the slide 120₃, . . . , and the to the 120ₙ per one clock.

The slide search unit 100 includes n comparators 111₁, 111₂, . . . , and 111ₙ and a logical sum circuit 110 having n inputs. Each of the n comparators 111₁, 111₂, . . . , and 111ₙ compares data input to one of the input terminal with data input to the other one of the input terminals and outputs “1” when the two match and “0” when the two do not match.

The outputs of the slides 120₁, 120₂, . . . , and 120ₙ included in the slide storage unit 101 are input to one of the input terminals of the comparators 111₁, 111₂, . . . , and 111ₙ, respectively. Further, input data is input to the other one of the input terminals of the comparators 111₁, 111₂, . . . , and 111ₙ.

The outputs of the comparators 111₁, 111₂, . . . , and 111ₙ are input to the logical sum circuit 110 having the n inputs, respectively, and also input to selectors (SEL) 131₁, 131₂, . . . , 131ₙ of the list search unit 102 which will be described later, respectively. An output of the logical sum circuit 110 is supplied to the controller 103 as the flag SFINDFLG. The flag SFINDFLG represents whether or not at least one of data in the slides 120₁, 120₂, . . . , and 120ₙ matches the input data.

The list search unit 102 includes n comparators 130₁, 130₂, . . . , 130ₙ, n selectors 131₁, 131₂, . . . , 131ₙ, n registers 132₁, 132₂, . . . , 132ₙ, an address value generating unit 133, and a logical sum circuit 134 having n inputs. Each of the n comparators 130₁, 130₂, . . . , and 130ₙ compares data input to one input terminal with data input to the other input terminal and outputs “1” when the two match and “0” when the two do not match.

The outputs of the slides 120₁, 120₂, . . . , and 120ₙ included in the slide storage unit 101 are input to the one input terminals of the comparators 130₁, 130₂, . . . , and 130ₙ, respectively. Further, input data is input to the other input terminals of the comparators 130₁, 130₂, . . . , and 130ₙ.

The outputs of the comparators 130₁, 130₂, . . . , and 130ₙ are input to the logical sum circuit 134 having the n inputs as the W flag WFLGm and also input to the other input terminals of the selectors 131₁, 131₂, . . . , 131ₙ, respectively. An output of the logical sum circuit 134 is supplied to the controller 103 as the flag LFINDFLG. The flag LFINDFLG represents that at least one of the flags WFLG1, WFLG2, . . . , WFLGn has a value of “1.”

The outputs of the selectors 131₁, 131₂, . . . , and 131ₙ are stored in the registers 132₁, 132₂, . . . , and 132ₙ, respectively, as the R flag RFLGm. The selectors 131₁, 131₂, . . . , and 131ₙ are controlled by the flag ListFLG supplied through a path (not illustrated) from the controller 103 to select one of the two terminals thereof.

When the value of the flag ListFLG is “0” and so represents that the slide search process is presently effective, the selectors 131₁, 131₂, . . . , and 131ₙ are controlled to supply the outputs of the comparators 111₁, 111₂, . . . , and 111ₙ in the slide search unit 100, which are input to the one input terminals thereof, to the registers 132₁, 132₂, . . . , and 132ₙ. For example, the selector 131ₘ (1≦m≦n) is controlled to select the one input terminal when the value stored in the corresponding register 132ₘ is “0.”

Meanwhile, when the value of the flag ListFLG is “1” and so represents that the list search process is presently effective, the selectors 131₁, 131₂, . . . , and 131ₙ are controlled to select and supply the outputs of the comparators 130₁, 130₂, . . . , and 130ₙ in the list search unit 102, which are respectively input to the other input terminals thereof, to the registers 132₁, 132₂, . . . , and 132ₙ. For example, the selector 131ₘ (1≦m≦n) is controlled to select the other input terminal when the value stored in the corresponding register 132ₘ is “1.”

When the outputs of the selectors 131₁, 131₂, . . . , and 131ₙ are received, the registers 132₁, 132₂, . . . , 132ₙ output the R flags RFLG1, RFLG2, . . . , and RFLGn stored therein. That is, the R flags RFLG1, RFLG2, . . . , and RFLGn stored in the registers 132₁, 132₂, . . . , and 132ₙ are updated by the outputs of the selectors 131₁, 131₂, . . . , and 131ₙ, respectively.

The R flags RFLG1, RFLG2, . . . , and RFLGn output from the registers 132₁, 132₂, . . . , and 132ₙ are supplied to control terminals of the comparators 130₁, 130₂, . . . , and 130ₙ as control signals that control operations of the comparators 130₁, 130₂, . . . , and 130ₙ. For example, the comparator 130ₘ performs a comparison operation when the control signal supplied from the corresponding register 132ₘ represents “1” and does not perform a comparison operation when the control signal represents “0.” This means that operations of the comparators 130₁, 130₂, . . . , and 130ₙ are narrowed down by outputs of the comparators 130₁, 130₂, . . . , and 130ₙ themselves.

The R flag RFLG1, RFLG2, . . . , RFLGn output from the registers 132₁, 132₂, . . . , 132ₙ are also supplied to the address value generating unit 133. As described in the process #5 of FIG. 4, the address value generating unit 133 selects the R flag RFLGm having a value of “1” from among the R flags RFLG1, RFLG2, . . . , RFLGn supplied from the registers 132₁, 132₂, . . . , 132ₙ when the list search process is finished and outputs a number of the selected R flag RFLGm as the address value Address. The address value Address output from the address value generating unit 133 is supplied to an address translation unit 144.

The address translation unit 144 contains the translation table ETRANSTABLE that has been described with reference to FIG. 10 and translates the received address value Address into the translation address value TAddress according to the translation table ETRANSTABLE. The translation address value TAddress translated from the address value Address is stored in the register 140 and also supplied to a controller 103.

The controller 103 generates the length Length and the header based on the flag SFINDFLG supplied from the slide search unit 100, the flag LFINDFLG supplied from the list search unit 102, and the translation address value TAddress supplied from the address translation unit 144. The length Length and the matching flag FLAG are stored in registers 143 and 142, respectively.

Further, the translation address value TAddress, the data value, the header, and the length Length are stored in the registers 140 to 143, respectively, are read out to the code format generation processing unit 302 and encoded into the code data according to the code format illustrated in FIG. 4.

In such a configuration, the slide search process is performed as follows. That is, the comparators 111₁, 111₂, . . . , and 111ₙ compare input data with past input data stored in the slides 120₁, 120₂, . . . , and 120ₙ. The comparison results are supplied to the logical sum circuit 110, so that the flag SFINDFLG is output. The comparison results are also supplied to the selectors 131₁, 131₂, . . . , and 131ₙ and stored in the registers 132₁, 132₂, . . . , and 132ₙ during the slide search process. According to the configuration of FIG. 17, this series of processes are executable in one clock.

Further, the list search process is performed as follows. That is, the comparators 130₁, 130₂, . . . , and 130ₙ compare input data with past input data stored in the slides 120₁, 120₂, . . . , and 120ₙ. At this time, the comparison operations of the comparators 130₁, 130₂, . . . , and 130ₙ are controlled based on the values of the R flags RFLG1, RFLG2, . . . , and RFLGn stored in the registers 132₁, 132₂, . . . , and 132ₙ. For example, when all of the values of the R flags RFLG1, RFLG2, . . . , and RFLGn are “0,” all of comparators 130₁, 130₂, . . . , and 130ₙ do not perform the comparison operation. This state is a state in which the list search process is not being performed.

The comparison results by the comparators 130₁, 130₂, . . . , and 130ₙ are supplied to the logical sum circuit 134, so that the flag LFINDFLG is output. The comparison results are supplied to the selectors 131₁, 131₂, . . . , and 131ₙ, respectively, and stored in the registers 132₁, 132₂, . . . , and 132ₙ during the list search process. The R flags RFLG1, RFLG2, . . . , and RFLGn stored in the registers 132₁, 132₂, . . . , and 132ₙ are also held in the address value generating unit 133.

The address value generating unit 133 outputs a position of the R flag RFLGm having a value of “1” among the R flags RFLG1, RFLG2, . . . , RFLGn retained therein to the controller 103 as the address value “Address” when all of the values retained in the registers 132₁, 132₂, . . . , 132ₙ are “0.” The address translation unit 144 translates the address value Address into the translation address value TAddress and transmits the translation address value TAddress to the controller 103. According to the configuration of FIG. 17, a series of processes by the list search process can be performed by one clock.

According to the configuration of FIG. 17, the slide search unit 100 and the list search unit 102 are separately configured, and the slide search unit 100 and the list search unit 102 share the slide storage unit 101. Therefore, it is possible to perform the slide search process by the slide search unit 100 and the list search process by the list search unit 102 in parallel. When the process is switched from the list search process to the slide search process, one clock is not wasted, whereby the encoding process can be performed at a higher speed. Further, according to the configuration of FIG. 17, since the look-ahead buffer or the large-scale matrix array is not required, the hardware scale can be reduced.

Further, a configuration of the encoder 242 is not limited to the configuration illustrated in FIG. 17. That is, the encoder may employ any other configuration to the extent that encoding of the LZ77 code is performed to output the length Length and the address value Address.

<Decoder>

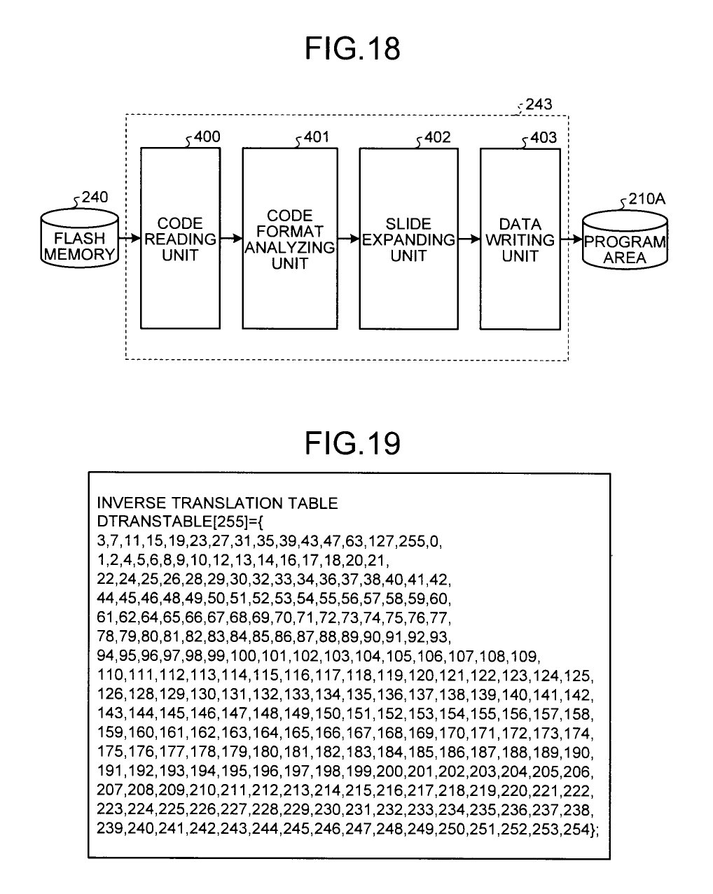

FIG. 18 illustrates an exemplary configuration of the decoder 243. In the decoder 243, a code reading unit 400 reads code data encoded by the encoder 242 from the flash memory 240. The code data read by the code reading unit 400 is supplied to a code format analyzing unit 401. The code format analyzing unit 401 analyzes the received code data according to the code format described with reference to FIG. 4 to extract the data value, the translation address value TAddress, the length Length, and the header. The extracted data is supplied to a slide expanding unit 402.

The slide expanding unit 402 has a slide storage unit in which a plurality of registers connected in series are configured as a FIFO as described above with reference to FIG. 5. Each register is called a slide and can store data of one unit (for example, one byte). The slide expanding unit 402 inversely translates the received translation address value TAddress into the original address value Address, expands data with respect to each slide in the slide storage unit based on the address value Address, the received data value, the length Length, and the header, and decodes the code data. The decoded data is supplied to a data writing unit 403 and written in the program area 210A of the main memory 210.

FIG. 19 illustrates an example of an inverse translation table DTRANSTABLE for translating the translation address value TAddress into the original address value Address. Numbers enumerated in the inverse translation table DTRANSTABLE represent the original address values Address. A value representing an order of the numbers enumerated in the inverse translation table DTRANSTABLE represents the translation address value TAddress.

That is, in the inverse translation table DTRANSTABLE, the translation address value TAddress “0” is translated into the original address value Address “3.” Further, the translation address value TAddress “15” is translated into the original address value Address “0.” Similarly, the translation address value TAddress “2” is translated into the original address value Address “11.”

<Details of a Decoding Process>

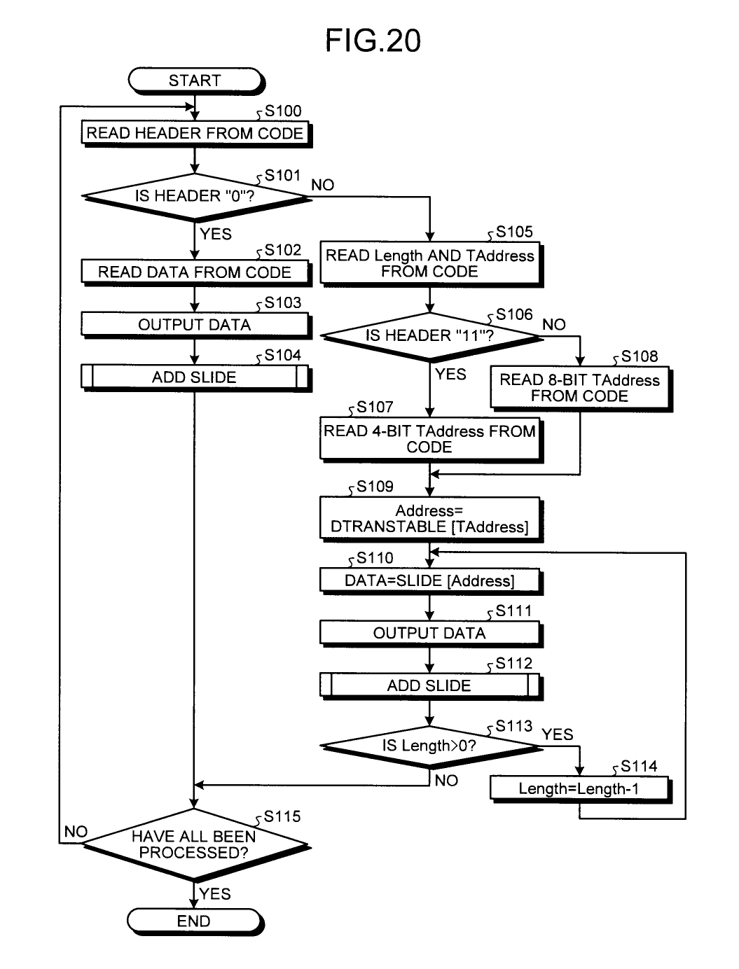

FIG. 20 is a flowchart illustrating an exemplary process of decoding code data encoded by an encoding scheme of the present embodiment through the decoder 243. Here, let us assume that code data is previously read in from the flash memory 240 by the code reading unit 400. First, in step S100, the code format analyzing unit 401 reads in a header of compression data read in to the code reading unit 400 and determines whether or not the value of the header is “0” (step S101).

When the header has a value of “0,” it is determined that the code having the corresponding header is the PASS code, and the process proceeds to step S102. In step S102, the code format analyzing unit 401 reads in eight (8) bits subsequent to the header as a data value. The read data value is output as output data “as is” (step S103) and supplied to the slide expanding unit 402 to be added to the slide (step S104). The process of adding the data value to the slide is performed in the same procedure as described above in the flowchart of FIG. 14. Then, the process proceeds to step S115.

In step S115, it is determined whether or not processing has been completed on all of code data read into the code reading unit 400. When it is determined that it has been completed on all of code data, a series of decoding processes are ended. However, when it is determined that processing has not been completed on all of code data read into the code reading unit 400 yet, the process returns to step S100, and the process is performed on a next code.

If it is determined that the value of the header is not “0,” the code format analyzing unit 401 shifts the process to step S105 and reads the 8 bits subsequent to the header as the length Length. The read length Length is supplied to the slide expanding unit 402.

In step S106, the code format analyzing unit 401 determines whether or not the value of the header is “11.” If it is determined that the value of the header is “11,” the code format analyzing unit 401 shifts the process to step S107 and reads the 4 bits subsequent to the header as the translation address value TAddress. However, if it is determined that the value of the header is not “11,” the process shifts to step S108, and 8 bits subsequent to the header is read as the translation address value TAddress. The translation address value TAddress read in step S107 or step S108 is supplied to the slide expanding unit 402.

In step S109, the slide expanding unit 402 translates the translation address value TAddress into the original address value Address using the inverse translation table DTRANSTABLE illustrated in FIG. 19.

In step S110, the slide expanding unit 402 reads in data, stored in the slide, represented by the address value “Address” of the slide storage unit. The read data is output as output data (step S111) and also supplied to the slide expanding unit 402 to be added to the slide (step S112).

The process proceeds to step S113, and it is determined whether or not the length “Length” is larger than “0.” When it is determined that the length “Length” is equal to or less than “0,” the process proceeds to step S115. However, when it is determined that the length “Length” is larger than “0,” in step S114, a value obtained by subtracting “1” from the length Length is used as a new length Length, and the process returns to step S110.

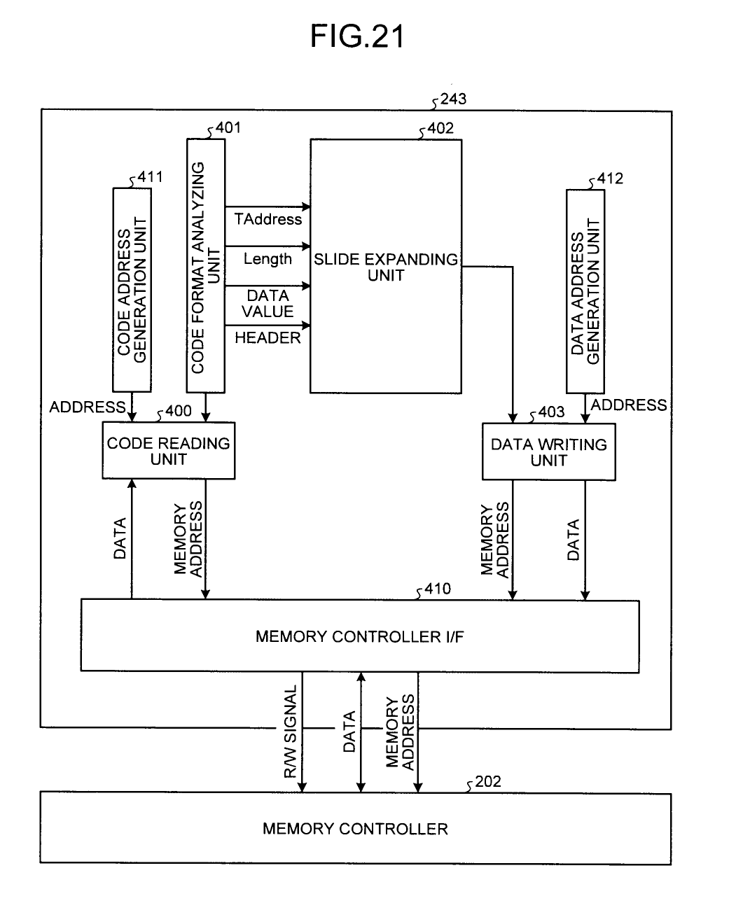

FIG. 21 is an exemplary configuration of the decoder 243 in further detail. In FIG. 21, the same parts as in FIG. 18 are denoted with the same reference numerals, and thus a description thereof will not be repeated. The decoder 243 includes the code reading unit 400, the code format analyzing unit 401, the slide expanding unit 402, the data writing unit 403, a memory controller I/F 410, a code address generation unit 411, and a data address generation unit 412.

The code address generation unit 411 generates a memory address for reading out the compression-encoded program data from the flash memory 240. The code reading unit 400 requests the memory controller 202 to read out data from the memory address generated by the code address generation unit 411 through the memory controller I/F 410. At the request, the code data, in which the program data is compression-encoded, read out from the flash memory 240 by the memory controller 202 is supplied from the memory controller 202 to the decoder 243. The code data is supplied to the code reading unit 400 through the memory controller I/F 410. The code reading unit 400 supplies the code format analyzing unit 401 with the code data.

The code format analyzing unit 401 extracts the header, the length Length, the data value, and the translation address value TAddress from the received code data according to the code format described in FIG. 4 and supplies with the slide expanding unit 402 with them. The translation address value TAddress is translated into the original address value Address using the inverse translation table DTRANSTABLE. The slide expanding unit 402 data with respect to each slide in the slide storage unit based on the address value Address, the received data value, the length Length, and the header, and decodes the code data into the original program data. The decoded program data is supplied to the data writing unit 403.

The data writing unit 403 supplies the memory controller 202 with the received program data through the memory controller I/F 410. Further, the data writing unit 403 requests the memory controller 202 to write the program data in the program area 210A of the main memory 210 according to the memory address generated by the data address generation unit 412 through the memory controller I/F 310. At the request, the memory controller 202 writes the received program data in the program area 210A of the main memory 210.

<Hardware Configuration of the Slide Expanding Unit>

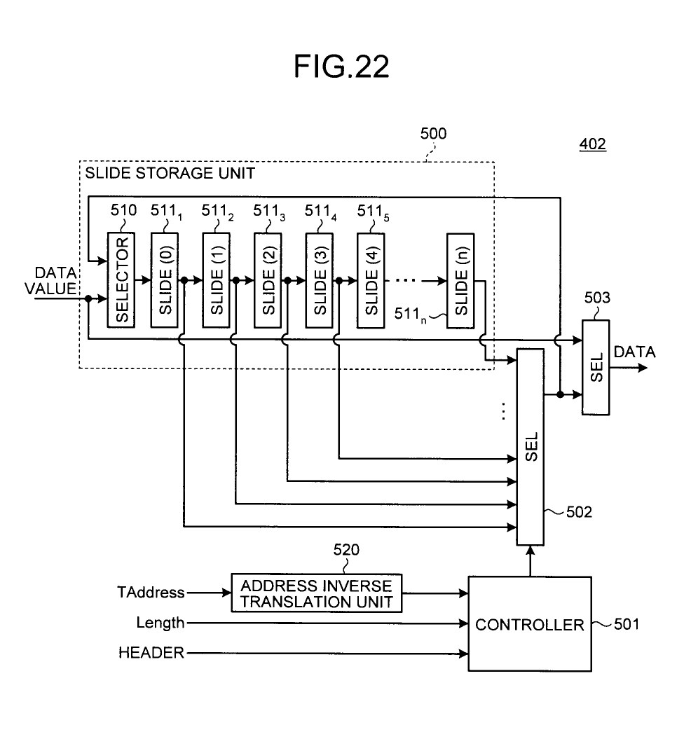

FIG. 22 illustrates an exemplary hardware configuration of the slide expanding unit 402. The slide expanding unit 402 includes a slide storage unit 500, a controller 501, selector 502 and 503, and an address inverse translation unit 520. The address inverse translation unit 520 contains the above described inverse translation table DTRANSTABLE, translates the translation address value TAddress supplied from the code format analyzing unit 401 into the original address value Address using the inverse translation table DTRANSTABLE, and transmits the original address value Address to the controller 501.

The controller 501 includes, for example, a microcontroller. The controller 501 receives the address value “Address,” the length “Length,” and the matching flag FLAG and controls an overall operation of the slide expanding unit 402 based on the received data. For example, the controller 501 controls the process of adding the data value to the slide in the slide storage unit 500 or operations of the selectors 502 and 503.

The slide storage unit 500 includes: a FIFO configuration with n slides 511₁, 511₂, . . . , and 511ₙ which are connected in series and which each include a register and stores data of one unit; and a selector 510 connected to the front of the FIFO configuration.

Outputs of the slides 511₁, 511₂, . . . , and 511ₙ are supplied to the selector 502. An output of the selector 502 is supplied to the selector 503 and also supplied to the selector 510.

The data value read from the code format analyzing unit 401 is supplied to the selector 510 and also supplied to the selector 503. The selector 510 adds the input data value to the slide 511₁ at the time of the slide adding process in step S104 of FIG. 13. Further, at the time of the slide adding process in step S104 of FIG. 13, data output from the slide selected based on the address value “Address” of the slide code in step S106 is added to the slide 511₁.

At the process in step S106 of FIG. 13, the selector 502 selects an output of the slide 511_{Address} from outputs of the slides 511₁, 511₂, . . . , and 511ₙ of the slide storage unit 500 based on the address value “Address” supplied from the controller 501 and supplies the selected output to the selectors 503 and 510.

In step S103 of FIG. 13, the selector 503 outputs the data value read in step S102. Further, at the time of the data output process in step S107 of FIG. 13, the selector 503 outputs the data supplied from the selector 502.

Further, a configuration of the decoder 243 is not limited to the configuration illustrated in FIG. 22. That is, the decoder may employ any other configuration to the extent that decoding of the LZ77 code is performed based on the length Length and the address value Address.

Further, the above description has been made in connection with the example in which the invention is applied to the printer apparatus. However, it is an example, and the invention is not limited to the above example. That is, the invention can be applied to any other device that performs lossless coding of program data based on a machine language using hardware.

According to the invention, there is an effect of being capable of providing a data processing apparatus and a data processing method that are appropriate for performing compression encoding and decoding processes of program data, particularly, based on a machine language.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A data processing apparatus, comprising:
a slide storage unit that sequentially stores input data;
a search unit that searches for a data string, which is stored in the slide storage unit, matched with an input data string including the input data that is continuously input;
a length generation unit that selects one from the data string searched by the search unit, obtains a length of the selected data string, and generates a length value;
an address value generation unit that obtains a position, in the slide storage unit, of start data in the data string used to generate the length value by the length generation unit and generates an address value;
a translation unit that translates a predetermined number of address values among address values having a high appearance frequency among address values generated by the address value generation unit into a translation address value having a value equal to or smaller than a predetermined value according to the appearance frequency of the address value; and
an encoding unit that encodes the length value and the translation address value.

2. The data processing apparatus according to claim 1,
wherein the translation unit translates a predetermined number of address values among address values that are high in appearance frequency of every predetermined unit of address values among address values generated by the address value generation unit into a translation address value having a value equal to or smaller than a predetermined value.

3. The data processing apparatus according to claim 2,
wherein the translation unit includes an address value that is high in entire appearance frequency from which the appearance frequency of every predetermined unit is excluded in the predetermined number of address values and translates the predetermined number of address values into a translation address value having a value equal to or smaller than a predetermined value.

4. The data processing apparatus according to claim 2,
wherein the predetermined unit is 4 bytes.

5. The data processing apparatus according to claim 1,
wherein the data is program data based on a machine language.

6. A data processing method, comprising:
causing a slide storage unit to sequentially store input data;
causing a search unit to search for a data string, which is stored in the slide storage unit, matched with an input data string including the input data that is continuously input;
causing a length generation unit to select one from the data string searched in the causing the search unit to search, obtain a length of the selected data string, and generate a length value;
causing an address value generation unit to obtain a position, in the slide storage unit, of start data in the data string used to generate the length value in the causing the length generation unit to generate, and generate an address value;
causing a translation unit to translate a predetermined number of address values among address values having a high appearance frequency among address values generated in the causing the address value generation unit to generate into a translation address value having a value equal to or smaller than a predetermined value according to the appearance frequency of the address value; and
causing an encoding unit to encode the length value and the translation address value.
